(19) United States
(12) Patent Application Publication
(10) Pub. No.: US 2025/0071456 A1
(43) Pub. Date: Feb. 27, 2025

(54) LOUDSPEAKER DEVICE

(71) Applicant: Panasonic Intellectual Property Management Co., Ltd., Osaka (JP)

(72) Inventors: Minami NAKA, Osaka (JP); Shuji SAIKI, Nara (JP); Akihisa KAWAMURA, Osaka (JP); Satoshi TAKAYAMA, Mie (JP)

(21) Appl. No.: 18/938,609

(22) Filed: Nov. 6, 2024

Related U.S. Application Data
(63) Continuation of application No. PCT/JP2023/017259, filed on May 8, 2023.
(60) Provisional application No. 63/340,561, filed on May 11, 2022.

(30) Foreign Application Priority Data
Apr. 26, 2023 (JP) 2023-072709

(51) Int. Cl. H04R 1/02

(52) U.S. Cl. CPC H04R 1/025

(57) ABSTRACT

A loudspeaker device includes: a loudspeaker unit; and a casing that defines an internal space in which the loudspeaker unit is housed. The casing includes a baffle board to which the loudspeaker unit is fixed in an orientation that exposes a diaphragm of the loudspeaker unit. The baffle board includes one or more through-holes that establish communication between an external space outside of the casing and the internal space. Sound that is emitted from the one or more through-holes has a wavelength with an inverted phase relative to sound emitted directly from the diaphragm to the external space.

### CROSS REFERENCE TO RELATED APPLICATIONS

This application is a continuation application of PCT International Patent Application Number PCT/JP2023/017259 filed on May 8, 2023, claiming the benefit of priority of U.S. Provisional Patent Application No. 63/340,561 filed on May 11, 2022 and Japanese Patent Application No. 2023-072709 filed on April 26 2023. The entire disclosures of the above-identified applications, including the specifications, drawings and claims are incorporated herein by reference in their entirety.

### FIELD

The present disclosure relates to a loudspeaker device.

### BACKGROUND

Patent Literature (PTL 1) discloses a loudspeaker-equipped headrest.

### CITATION LIST

### Patent Literature

PTL 1: Japanese Unexamined Patent Application Publication (Translation of PCT Application) No. 2017-525456

### SUMMARY

### Technical Problem

However, in the technique in PTL1, the sound reproduced from the loudspeaker is conveyed to the periphery of the seat to which the loudspeaker-equipped headrest is provided. For this reason, for example, when a person is seated in a neighboring seat in the periphery of the seat, the sound reproduced by the loudspeaker can be heard by the person seated in the neighboring seat.

In view of this, the present disclosure provides a loudspeaker device capable of making the reproduced sound less audible to a person other than a person who is the target listener.

### Solution to Problem

A loudspeaker device according to an aspect of the present disclosure includes: a loudspeaker unit; and a casing that defines an internal space in which the loudspeaker unit is housed, wherein the casing includes a baffle board to which the loudspeaker unit is fixed in an orientation that exposes a diaphragm of the loudspeaker unit, the baffle board includes one or more first through-holes that establish communication between an external space outside of the casing and the internal space, and sound that is emitted from the one or more first through-holes has a wavelength with an inverted phase relative to sound emitted directly from the diaphragm to the external space.

### Advantageous Effects

The loudspeaker device according to the present disclosure is capable of making sound emitted from a loudspeaker less audible to a person other than a person who is a target listener.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is an external view of a chair including loudspeaker devices according to an embodiment.

FIG. 2 is a diagram illustrating an example of the external appearance of a loudspeaker device according to the embodiment.

FIG. 3 is a perspective view including a cross-section obtained when the loudspeaker device according to the embodiment is cut along a plane including a central axis of the loudspeaker device.

FIG. 4 is a diagram for describing sounds reproduced from the loudspeaker device.

FIG. 5 is a graph illustrating sound pressure-frequency response of loudspeaker devices according to a comparative example and the embodiment.

FIG. 6 is a perspective view including a cross-section obtained when a loudspeaker device according to Variation 1 is cut along a plane including a central axis of the loudspeaker device.

FIG. 7 is a graph illustrating the sound absorption coefficient for each frequency of a sound absorbing module having a specific structure.

FIG. 8 is a diagram illustrating an example of the external appearance of a loudspeaker device according to Variation 2.

FIG. 9 is a perspective view illustrating an example of the appearance of an acoustic lens.

FIG. 10 is a view of the acoustic lens as seen from the side.

FIG. 11 is a cross-sectional view of the acoustic lens.

### DESCRIPTION OF EMBODIMENTS

A loudspeaker device according to a first aspect includes: a loudspeaker unit; and a casing that defines an internal space in which the loudspeaker unit is housed, wherein the casing includes a baffle board to which the loudspeaker unit is fixed in an orientation that exposes a diaphragm of the loudspeaker unit, the baffle board includes one or more first through-holes that establish communication between an external space outside of the casing and the internal space, and sound that is emitted from the one or more first through-holes has a wavelength with an inverted phase relative to sound emitted directly from the diaphragm to the external space.

Accordingly, since one or more first through-holes that establish communication between the internal space of the casing and the external space are provided in the baffle board to which the loudspeaker unit is fixed, sound reproduced by the loudspeaker unit is cancelled by the sound that is emitted from the one or more first through-holes which has an inverted phase relative to the sound reproduced by the loudspeaker unit. In particular, since sound in the low-frequency side that tends to sneak around the periphery of the loudspeaker device is cancelled out, it is possible to reduce the sound that can be heard by a person located in the periphery of the loudspeaker unit.

A loudspeaker device according to a second aspect is the loudspeaker device according to the first aspect, in which the one or more first through-holes are disposed in a second region that is other than a first region in the baffle board, the first region extending a predetermined distance from the loudspeaker unit.

For this reason, it is possible to make the sound emitted to the front of the loudspeaker unit hard to cancel, and the sound emitted from the loudspeaker unit can be controlled to have forward directivity.

A loudspeaker device according to a third aspect is the loudspeaker device according to the first aspect or the second aspect, further including a first sound absorbing body disposed in the internal space, at a position that is closer to the baffle board of the casing than to a base panel located at a position opposite to the baffle board.

For this reason, the volume of sound emitted from the one or more first through-holes can be regulated. Therefore, the extent to which the sound emitted from the loudspeaker unit is to be cancelled out can be easily regulated.

A loudspeaker device according to a fourth aspect is the loudspeaker device according to the third aspect, in which the casing further includes a partition board in which a plurality of second through-holes are provided, the partition board partitioning the internal space into a first space that is closer to the baffle board and a second space that is closer to the base panel.

For this reason, the state in which the first sound absorbing body is disposed in the first space can be maintained, and the regulated state of the volume of sound emitted from the one or more first through-holes can be easily maintained.

A loudspeaker device according to a fifth aspect is the loudspeaker device according to the fourth aspect, further including a second sound absorbing body disposed in the second space.

For this reason, the volume of sound emitted from the one or more first through-holes can be further regulated.

A loudspeaker device according to a sixth aspect is the loudspeaker device according to any one of the first to fifth aspects, in which the casing includes a third through-hole that is disposed in a portion other than the baffle board and establishes communication between the external space and the internal space.

Accordingly, since a third through-hole that establishes communication between the internal space of the casing and the external space is further provided in a portion other than the baffle board, the sound reproduced by the loudspeaker unit is further cancelled out by the sound emitted from the second through hole which has an inverted phase relative to the sound reproduced by the loudspeaker unit. In particular, since sound in the low-frequency side that tends to sneak around the periphery of the loudspeaker is cancelled out, it is possible to reduce the sound that can be heard by a person located in the periphery of the loudspeaker unit.

A loudspeaker device according to a seventh aspect is the loudspeaker device according to any one of the first to fifth aspects, in which the loudspeaker device is a sound absorbing module that forms a Helmholtz resonator.

For this reason, the speaker device can also function as a sound absorbing module.

A loudspeaker device according to an eighth aspect is the loudspeaker device according to any one of the first to fifth aspects, further including an acoustic lens disposed at a position that is outward of the diaphragm and covers the diaphragm.

For this reason, sound in the high frequency band can be controlled by the acoustic lens so as to have forward directivity. Therefore, the loudspeaker device can control the directivity of, not only sound in the low frequency side, but also sound in the high frequency side.

A loudspeaker device according to a ninth aspect is the loudspeaker device according to the eighth aspect, in which the acoustic lens includes: a first route located at a position that coincides with a central axis of the loudspeaker unit; and a second route that is located in a periphery of the first route and has a length that is shorter than a length of the first route. Accordingly, sound in the high frequency band can be controlled to have forward directivity. A loudspeaker device according to a tenth aspect is the loudspeaker device according to the ninth aspect, in which the acoustic lens includes: a plurality of tabular components each of which includes a plurality of through holes; and a support component that supports the baffle board and the plurality of tabular components in a state in which the baffle board and the plurality of tabular components are spaced apart from each other.

Hereinafter, a loudspeaker according to an aspect of the present disclosure will be described in detail with reference to the Drawings.

It should be noted that each of the embodiments described hereafter illustrates a specific example of the present invention. The numerical values, shapes, materials, structural components, the arrangement and connection of the structural components, steps, the processing order of the steps, etc., shown in the following embodiments are mere examples, and are therefore not intended to limit the present invention. Furthermore, among the structural components in the following embodiments, structural components not recited in any one of the independent claims defining the most generic concepts are described as arbitrary structural components.

### Embodiment

The configuration of a loudspeaker device according to an embodiment will be described.

### 1. Configuration

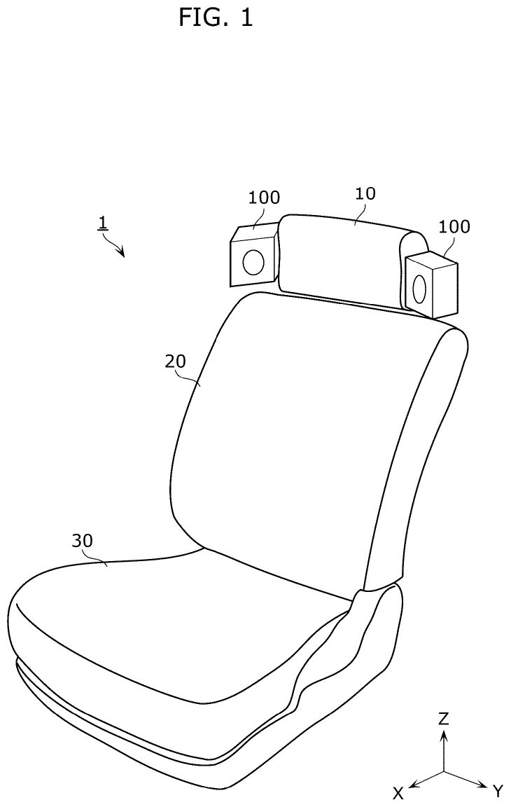

FIG. 1 is an external view of a chair including loudspeaker devices according to an embodiment.

As illustrated in FIG. 1, chair 1 includes two loudspeaker devices 100, headrest 10, backrest 20, and seat surface 30. The two loudspeaker devices 100 are disposed at the left and right of headrest 10. The two loudspeaker devices 100 may be arranged to be tilted relative to the X-axis direction so as to emit sound toward the position of the head of a person sitting in chair 1 (that is, a position in front of headrest 10). Chair 1 is, for example, a seat disposed in a vehicle such as an automobile, aircraft, watercraft, and the like. It should be noted that chair 1 is not limited to a seat disposed inside the cabin of a vehicle, and may be a seat disposed in a movie house, a theater, or a meeting room, or may be chair with a cushion, a legless chair, a sofa, a massage chair, and so on. Moreover, although chair 1 has a configuration in which two loudspeaker devices 100 are provided, chair 1 may have a configuration in which only one loudspeaker device 100 is provided, or a configuration in which three or more loudspeaker devices 100 are provided.

Headrest 10 is a part that supports the head of a person when the person is seated on chair 1. Backrest 20 is a part that supports the back of a person when the person is seated on chair 1. Seat surface 30 is a part that supports the femoral region of a person when the person sits on chair 1.

Hereinafter, description will be carried out with the front-back direction of chair 1 being referred to as the X-axis direction, the left-right direction of chair 1 as the Y-axis direction, and the up-down direction of chair 1 as the Z-axis direction. Furthermore, description will be carried out with the front side in the front-back direction being referred to as the X-axis plus side, the back side in the front-back direction as the X-axis minus side, the left side in the right-left direction as the Y-axis plus side, the right side in the right-left direction as the Y-axis minus side, the up side in the up-down direction as the Z-axis plus side, and the down side in the up-down direction as the Z-axis minus side.

It should be noted that in the subsequent description, each of each of the above-mentioned directions is described under the assumption that backrest 20 is not tilted to the back by reclining, and is in an upright state along the Z-axis direction.

Furthermore, in the present description, the front side of loudspeaker device 100 is the side on which a diaphragm of a loudspeaker unit included in loudspeaker device 100 is disposed, and the back side of loudspeaker device 100 is the side on which a magnetic circuit included in loudspeaker device 100 is disposed. In other words, in front of the loudspeaker indicates a direction that is from the magnetic circuit to the diaphragm of the loudspeaker, and behind the loudspeaker indicates a direction that is from the diaphragm to the magnetic coil.

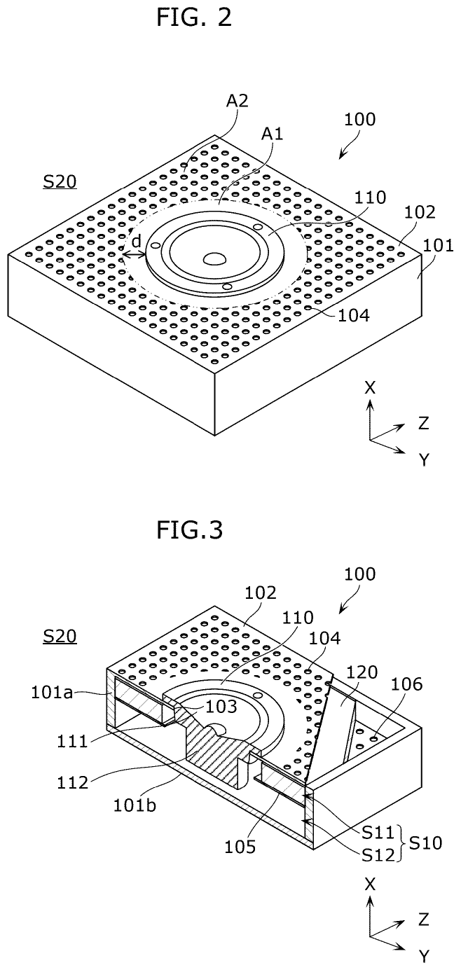

FIG. 2 is a diagram illustrating an example of the external appearance of a loudspeaker device according to the embodiment. FIG. 3 is a perspective view including a cross-section obtained when the loudspeaker device according to the embodiment is cut along a plane including a central axis of the loudspeaker device. It should be noted that, in FIG. 3, a portion of the baffle board and a portion of the sound absorbing body of the loudspeaker device are omitted in order to make the internal configuration easier to understand.

As illustrated in these figures, loudspeaker device 100 includes casing 101 and loudspeaker unit 110. Loudspeaker device 100 further includes sound absorbing body 120 and partition board 105.

Casing 101 is a box-type component that is of a rectangular parallelepiped shape. Casing 101 includes baffle board 102 disposed at the front, four side panels 101a disposed at the sides (four sides) of loudspeaker unit 110, and base panel 101b that is located at a position opposite to baffle board 102 in the X-axis direction. Casing 101 defines internal space S10 in which at least a portion (for example, magnetic circuit 112) of loudspeaker unit 110 is housed. Casing 101 is a loudspeaker cabinet. It should be noted that casing 101 is not limited to a rectangular parallelepiped shape, and may be cylindrical, spherical, oval, or other three-dimensional shape.

Baffle board 102 includes opening portion 103 into which loudspeaker unit 110 is attached. Opening portion 103 is provided, for example, at the center of baffle board 102. Opening portion 103 may be provided at a position that is offset from the center of baffle board 102. Loudspeaker unit 110 is fixed, to opening portion 103 of baffle board 102, in an orientation that exposes diaphragm 111 of loudspeaker unit 110. Baffle board 102 includes through-holes 104 that establish communication between external space S20 outside casing 101 and internal space S10. The number of through-holes 104 provided to baffle board 102 is not limited to a plurality, and may be one. Through-holes 104 are disposed in second region A2 that is other than first region A1 extending a predetermined distance d from loudspeaker unit 110, in baffle board 102. In other words, through-holes 104 are not disposed in first region A1. Furthermore, the size of each of through-holes 104 is smaller than the size of opening portion 103.

Casing 101 is made of, for example, metal, resin, wood, or the like.

Loudspeaker unit 110 includes diaphragm 111, magnetic circuit 112, and a voice coil not shown in the figures.

Sound absorbing body 120 is disposed in first space S11 included in internal space S10. In other words, sound absorbing body 120 is disposed at a position that is closer to baffle board 102 than to base panel 101b located at a position opposite to baffle board 102 in casing 101. Sound absorbing body 120 is restricted by partition board 105 so as not to move from its position in first space S11. It should be noted that it is sufficient that sound absorbing body 120 is restricted by a component other than partition board 105 (for example, projections provided in side panels 101a) so as not to move from its position in first space S11. For this reason, loudspeaker device 100 need not necessarily include partition board 105. Sound absorbing body 120 is an example of a first sound absorbing body.

Partition board 105 is a tabular component that partitions internal space S10 into first space S11 on the baffle board 102-side (that is, the front side) and second space S12 on the base panel 101b-side (that is, the back side). Furthermore, partition board 105 includes through-holes 106. Specifically, first space S11 and second space S12 are in a communicating state by way of through-holes 106 of partition board 105. Through-holes 106 is an example of second through-holes. The size of each of through-holes 106 is smaller than the size of opening portion 103. The size of each of through-holes 106 may be the same as or different from the size of each of through-holes 104. It should be noted that first space S11 and second space S12 may be of a flat shape in which the width in the X-axis direction is shorter than the width in the other directions (that is, the Y-axis direction and the Z-axis direction).

Since through-holes 104 are formed in baffle board 102 of casing 101, loudspeaker device 100 also functions as a sound absorbing module that forms a Helmholtz resonator having through-holes 104 as openings and casing 101 as a container. Furthermore, since through-holes 106 are formed in partition board 105 of casing 101, loudspeaker device 100 forms a dual-structure Helmholtz resonator.

### 2. Advantageous Effects, Etc.

Loudspeaker device 100 according to the present embodiment includes loudspeaker unit 110 and casing 101. Casing 101 defines internal space S10 in which loudspeaker unit 110 is housed. Casing 101 includes baffle board 102 to which loudspeaker unit 110 is attached in an orientation that exposes diaphragm 111 of loudspeaker unit 110. Baffle board 102 includes through-holes 104 that establish communication between external space S20 outside casing 101 and internal space S10.

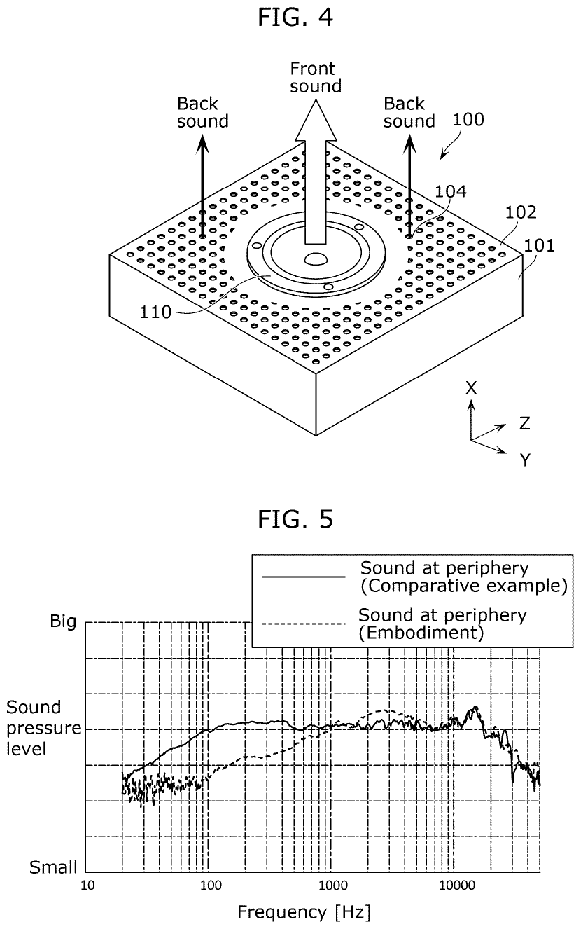

FIG. 4 is a diagram for describing sounds reproduced from the loudspeaker device.

Accordingly, through-holes 104 that establish communication between internal space S10 of casing 101 and external space S20 are provided in baffle board 102 to which loudspeaker unit 110 is fixed. For this reason, sound reproduced by loudspeaker unit 110 is cancelled by sound that is emitted from through-holes 104 and that has an inverted phase relative to the sound reproduced by loudspeaker unit 110. Specifically, as illustrated in FIG. 4, sound emitted from loudspeaker device 100 includes front sound that is emitted toward the front from the front face of diaphragm 111 of loudspeaker unit 110 and back sound that is emitted toward the back from the back face of diaphragm 111 and then emitted from through-holes 104. Since front sound and back sound are in a mutual inverted phase relationship, overlapping the front sound with the back sound causes each other's sound to be cancelled out. Specifically, the back sound emitted from through-holes 104 has a wavelength with an inverted phase relative to the front sound emitted directly toward external space S20 from diaphragm 111. In particular, since sound in the low-frequency side that tends to sneak around the periphery of loudspeaker device 100 is easy to cancel out, it is possible to reduce the sound that can be heard by a person located in the periphery of loudspeaker unit 110.

FIG. 5 is a graph illustrating sound pressure-frequency response of loudspeaker devices according to a comparative example and the embodiment.

In FIG. 5, the solid line graph illustrates the sound pressure-frequency response of sound reproduced from loudspeaker device 100, taken at a space of the target listener. The intended listening space is the space in front of loudspeaker device 100, and is the space in front of headrest 10 and in which the head of a person is located when the person is seated in chair 1. The solid line graph illustrates the sound pressure-frequency response of the sound reproduced from loudspeaker device 100, taken at the position of the ears of the person seated in chair 1. The dotted line graph illustrates the sound pressure-frequency response of sound reproduced from loudspeaker device 100 according to the present embodiment, taken at a space in the periphery of the target listener. It should be noted that the space in the periphery of the target listener is a space other than the space of the target listener, and is, for example, the space behind loudspeaker device 100.

As illustrated in FIG. 5, it can be seen that the sound pressure level of the sound from loudspeaker device 100 that can be heard in the space in the periphery of the target listener is suppressed compared to the sound that can be heard by the person seated in chair 1.

In loudspeaker device 100 according to the present embodiment, through-holes 104 are disposed in second region A2 that is other than first region A1 extending a predetermined distance d from loudspeaker unit 110, in baffle board 102.

For this reason, it is possible to make the sound emitted to the front of loudspeaker unit 110 hard to cancel, and the sound emitted from loudspeaker unit 110 can be controlled to have forward directivity.

Loudspeaker device 100 according to the present embodiment further includes sound absorbing body 120 disposed in internal space S10, at a position that is closer to baffle board 102 of casing 101 than to base panel 101b located at a position opposite to baffle board 102.

For this reason, the volume of sound emitted from through-holes 104 can be regulated. Therefore, the extent to which the sound emitted from loudspeaker unit 110 is to be cancelled out can be easily regulated.

In loudspeaker device 100 according to the present embodiment, casing 101 further includes partition board 105 that partitions internal space S10 into first space S11 on the baffle board 102-side and second space S12 on the base panel 101b-side, and in which second through-holes 106 are formed. Sound absorbing body 120 is disposed in first space S11.

For this reason, the state in which sound absorbing body 120 is disposed in first space S11 can be maintained, and the regulated state of the volume of sound emitted from through-holes 104 can be easily maintained.

Loudspeaker device 100 according to the present embodiment is a sound absorbing body that forms a Helmholtz resonator. For this reason, loudspeaker device 100 can also function as a sound absorbing body that makes use of the effects of a Helmholtz resonator.

### 3. Variations

### 3-1. Variation 1

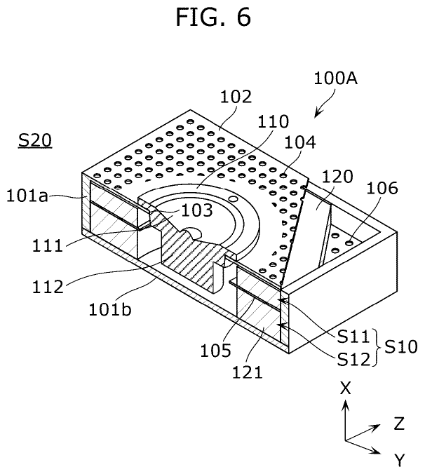

FIG. 6 is a perspective view including a cross-section obtained when a loudspeaker device according to Variation 1 is cut along a plane including a central axis of the loudspeaker device.

Loudspeaker device 100A according to Variation 1 is different compared to loudspeaker device 100 according to the embodiment in terms of including sound absorbing body 121. Since structural components of loudspeaker device 100A other than sound absorbing body 121 are the same as those in loudspeaker device 100, their detailed description will be omitted.

Sound absorbing body 121 is disposed in second space S12 of casing 101. In other words, two sound absorbing bodies, 120 and 121, are disposed in internal space S10 of casing 101, with partition board 105 interposed therebetween.

In this manner, since the two sound absorbing bodies 120 and 121 are provided, the volume of the sound emitted from through-holes 104 can be further regulated.

It should be noted that, in FIG. 6, casing 101 has a configuration that includes baffle board 102 having through-holes 104 and partition board 105 having through-holes 106, and in which the two sound absorbing bodies 120 and 121 are respectively disposed in first space S11 and second space S12 that are separated by partition board 105. In other words, the combination of casing 101, partition board 105, and the two sound absorbing bodies 120 and 121 forms a sound absorbing module.

The sound absorbing module having the above described configuration includes a Helmholtz resonator composed of through-holes 104 of baffle board 102 and first space S10, and a Helmholtz resonator composed of through-holes 106 of partition board 105 and second space S12. In other words, the sound absorbing module includes two Helmholtz resonators. By setting different values for the two resonance frequencies of these two Helmholtz resonators, a sound absorption effect over a wide frequency band can be obtained.

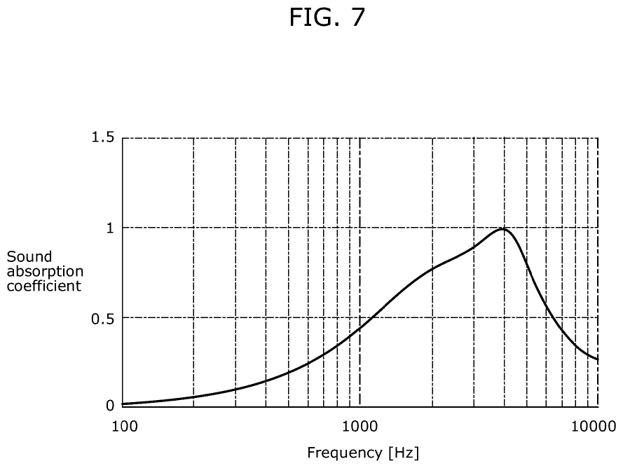

For example, with regard to the structure of the sound absorbing module, by providing a specific structure in which the thickness of baffle board 102 is 1 mm, the diameter of each through-hole 104 is φ 4 mm, the opening ratio of through-holes 104 with respect to the surface area of baffle board 102 is 22%, the thickness of partition board 105 is 1 mm, the diameter of each through-hole 106 is φ 4 mm, the opening ratio of through-holes 106 with respect to the surface area of partition board 105 is 5%, the thickness of first space S11 is 11 mm, the thickness of second space S12 is 24 mm, and sound absorbing bodies 120 and 121 are disposed to respectively fill the spaces, the sound absorption coefficient for each frequency on the top surface side of baffle board 102 becomes like the graph illustrated in FIG. 7. FIG. 7 is a graph illustrating the sound absorption coefficient for each frequency of a sound absorbing module having a specific structure. It should be noted that the thickness of first space S11 and second space S12 refers to their width (length) in the front-back direction (X-axis direction in the figures) of loudspeaker unit 110.

As illustrated in FIG. 7, as a sound absorbing module having a two-layer structure, a high sound absorption coefficient of at least 0.5 is obtained in the 1 kHz to 6 kHz band. Accordingly, sound in the vicinity of 3 kHz to which the sensitivity of human ears is particularly high can be effectively absorbed, and thus it is possible to absorb the sound emitted from loudspeaker unit 110 to the space in the periphery of the target listener and suppress the sound pressure level of unwanted leaking sound. Furthermore, since unwanted noise conveyed from the space in the periphery of the target listener is also absorbed, there is also an expected silencing effect at the position where the person is seated.

It should be noted the frequency band for which sound absorption is achieved is arbitrarily designed according to the thickness of baffle board 102, the diameter of each through-hole 104, the opening ratio of through-holes 104 with respect to the surface area of baffle board 102, and, additionally, the thickness of first space S11 and second space S12, and so on, and thus it is preferable set to match the noise, and so on, in environment in which loudspeaker device 100A is to be disposed.

### 3-2. Variation 2

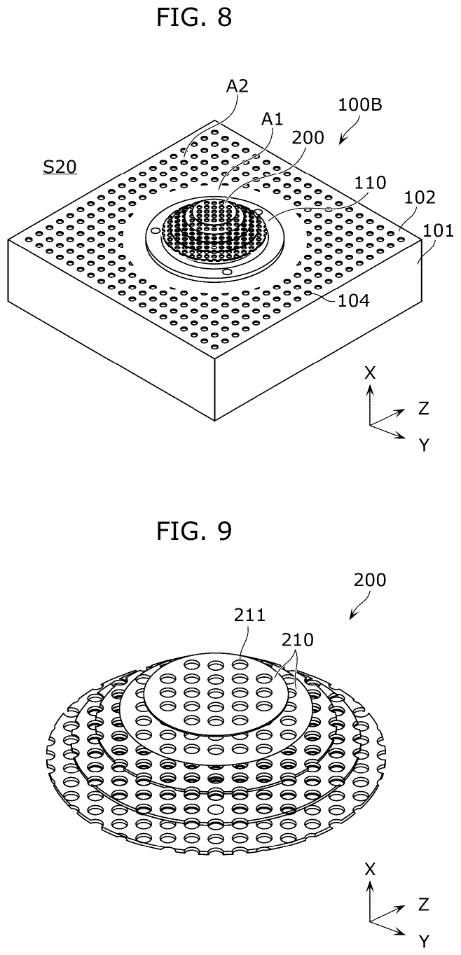

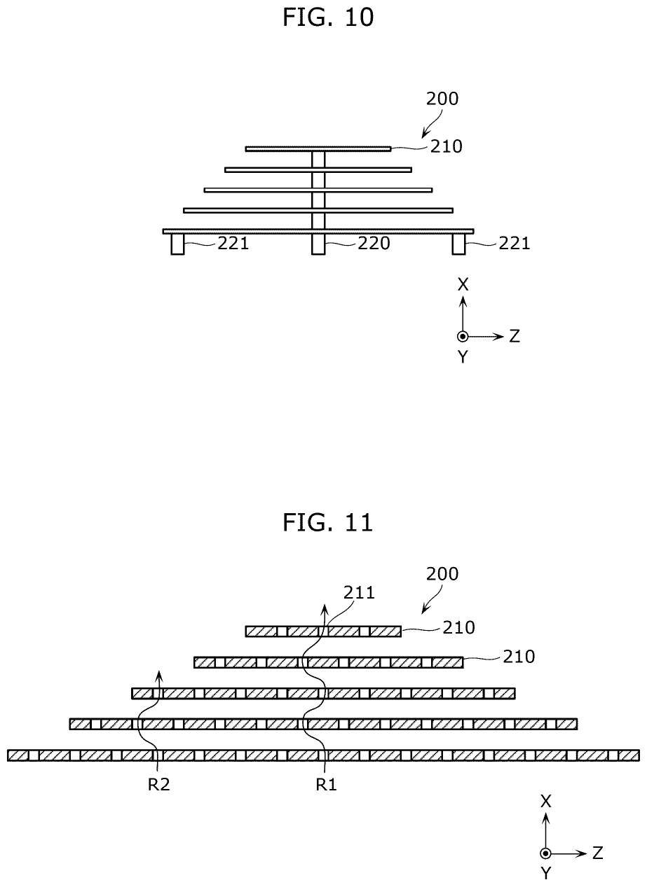

FIG. 8 is a diagram illustrating an example of the external appearance of a loudspeaker device according to Variation 2. FIG. 9 is a perspective view illustrating an example of the appearance of an acoustic lens. FIG. 10 is a view of the acoustic lens as seen from the side. FIG. 11 is a cross-sectional view obtained when the acoustic lens is cut in near the center axis of the acoustic lens.

Loudspeaker device 100B according to Variation 2 is different compared to loudspeaker device 100 according to the embodiment in terms of including acoustic lens 200. Since structural components of loudspeaker device 100B other than acoustic lens 200 are the same as those in loudspeaker device 100, their detailed description will be omitted.

Acoustic lens 200 is disposed in a position that is outward (that is, on the front side) of diaphragm 111 of loudspeaker unit 110 of loudspeaker device 100B, and that covers diaphragm 111. Acoustic lens 200 includes tabular components 210 and support components 220 and 221.

Each of tabular components 210 includes through-holes 211. The size of the contour of tabular components 210 becomes smaller toward the X-axis direction plus side. Specifically, tabular components 210 are such that, between two adjacent tabular components 210, the size of the contour of tabular component 210 on the X-axis direction plus side is smaller than the size of the contour of tabular component 210 on the X-axis direction minus side. Through-holes 211 of two adjacent tabular components 210 are disposed at positions that do not overlap each other when seen from the X-axis direction.

Support component 220 supports tabular components 210 in a state in which tabular components 210 are spaced apart from each other. Support portions 221 and a portion of support component 220 support tabular component 210 disposed furthest on the X-axis direction minus side, among tabular components 210, and baffle board 102 in a state in which such tabular component 210 and baffle board 102 are spaced apart. Acoustic lens 200 is made of metal, resin, or the like, for example.

As illustrated in FIG. 11, with the above-described configuration, acoustic lens 200 can make the passing distance of sound passing through first route R1 near the center of the sound emitted from loudspeaker unit 110 longer than the passing distance of sound passing through second route R2 in the periphery (i.e., outward) of first route R1, and thus its phase is delayed more than the phase of sound in the vicinity of loudspeaker unit 110 (that is, in the periphery of the center of loudspeaker unit 110). Specifically, acoustic lens 200 includes first route R1 located at a position opposite to the central axis of loudspeaker unit 110, and second route R2 that is located in the periphery of first route R1 and has a length shorter than the length of first route R1

Accordingly, the directivity of sound emitted from loudspeaker unit 110 becomes sharper at the front, and thus leaking of sound to the vicinity can be reduced. In particular, acoustic lens 200 can control sound in the high frequency band so that the sound has forward directivity.

In this manner, sound in the high frequency band can be controlled by acoustic lens 200 so as to have forward directivity. Therefore, loudspeaker device 100B according to Variation 2 can control the directivity of, not only sound in the low frequency side, but also sound in the high frequency side.

It should be noted that, although acoustic lens 200 including tabular components 210 each having through-holes 211 is given as an example in Variation 2, the acoustic lens is not limited to this configuration. The acoustic lens may have any configuration as long as the passing distance of sound passing through first route R1 near the center of the sound emitted from loudspeaker unit 110 is longer than the passing distance of sound passing through second route R2 in the periphery of first route R1. For example, the acoustic lens may be configured by stacking boards of porous material having different contours, or may be configured by a conical block of a porous material whose diameter decreases toward the apex.

### 3-3. Variation 3

In the above described embodiment, casing 101 of loudspeaker device 100, 100A, and 100B has a configuration in which baffle board 102 includes through holes 104, but is not limited to this configuration. For example, casing 101 may also include a third through-hole that is disposed in a portion other than baffle board 102 and establishes communication between external space S20 and internal space S10. This third through hole may be provided in side panel 101a or in base panel 101b of casing 101. Furthermore, a plurality of third through holes may be provided in any one of side panel 101a or base panel 101b.

Accordingly, since a third through-hole that establishes communication between internal space S10 of casing 101 and external space S20 is further provided in a portion other than baffle board 102, the sound reproduced by loudspeaker unit 110 is further cancelled out by the sound emitted from the third through hole which has an inverted phase relative to the sound reproduced by loudspeaker unit 110. In particular, since sound in the low-frequency side that tends to sneak around the periphery of loudspeaker device 100, 100A, and 100B is cancelled out, it is possible to reduce the sound that can be heard by a person located in the periphery of loudspeaker unit 110.

Although a loudspeaker device according to one aspect the present disclosure or variations of the aspect have been described thus far based on the foregoing embodiment, the present disclosure is not limited to the foregoing embodiment. Various modifications to the present embodiment that can be conceived by a skilled person or forms obtained by combining structural components in different embodiments, for as long as they do not depart from the essence of the present disclosure, may be included in the scope of one or more aspects of the present disclosure.

### INDUSTRIAL APPLICABILITY

The present disclosure is useful as a loudspeaker device, or the like, that is capable of making sound emitted from a loudspeaker less audible to a person other than a person who is an intended listener.

1. A loudspeaker device comprising:
a loudspeaker unit; and
a casing that defines an internal space in which the loudspeaker unit is housed, wherein
the casing includes a baffle board to which the loudspeaker unit is fixed in an orientation that exposes a diaphragm of the loudspeaker unit,
the baffle board includes one or more first through-holes that establish communication between an external space outside of the casing and the internal space, and
sound that is emitted from the one or more first through-holes has a wavelength with an inverted phase relative to sound emitted directly from the diaphragm to the external space.

2. The loudspeaker device according to claim 1, wherein
the one or more first through-holes are disposed in a second region that is other than a first region in the baffle board, the first region extending a predetermined distance from the loudspeaker unit.

3. The loudspeaker device according to claim 1, further comprising:
a first sound absorbing body disposed in the internal space, at a position that is closer to the baffle board of the casing than to a base panel located at a position opposite to the baffle board.

4. The loudspeaker device according to claim 3, wherein
the casing further includes a partition board in which a plurality of second through-holes are provided, the partition board partitioning the internal space into a first space that is closer to the baffle board and a second space that is closer to the base panel.

5. The loudspeaker device according to claim 4, further comprising:
a second sound absorbing body disposed in the second space.

6. The loudspeaker device according to claim 1, wherein
the casing includes a third through-hole that is disposed in a portion other than the baffle board and establishes communication between the external space and the internal space.

7. The loudspeaker device according to claim 1, wherein
the loudspeaker device is a sound absorbing module that forms a Helmholtz resonator.

8. The loudspeaker device according to claim 1, further comprising:
an acoustic lens disposed at a position that is outward of the diaphragm and covers the diaphragm.

9. The loudspeaker device according to claim 8, wherein
the acoustic lens includes:
a first route located at a position that coincides with a central axis of the loudspeaker unit; and
a second route that is located in a periphery of the first route and has a length that is shorter than a length of the first route.

10. The loudspeaker device according to claim 9, wherein
the acoustic lens includes:
a plurality of tabular components each of which includes a plurality of through holes; and
a support component that supports the baffle board and the plurality of tabular components in a state in which the baffle board and the plurality of tabular components are spaced apart from each other.
